(19) United States
(12) Patent Application Publication
(10) Pub. No.: US 2026/0369446 A1
(43) Pub. Date: Nov. 19, 2026

(54) DATA CABLE

(71) Applicant: GEBAUER & GRILLER KABELWERKE GESELLSCHAFT M.B.H., Wien (AT)

(72) Inventors: Johannes BÖHM, Siebenhirten (AT); Robert FRÜHWIRTH, Altruppersdorf (AT); Tobias KUPKA, Wien (AT); Marijan ROGIC, St. Pölten (AT)

(73) Assignee: GEBAUER & GRILLER KABELWERKE GESELLSCHAFT M.B.H., Wien (AT)

(21) Appl. No.: 19/132,417

(22) PCT Filed: Nov. 24, 2023
(86) PCT No.: PCT/EP2023/082969

§ 371 Date: May 23, 2025

(30) Foreign Application Priority Data
Nov. 25, 2022 (EP) 22209658.8

(51) Int. Cl. H01B 11/10; H01B 7/36

(52) U.S. Cl. CPC H01B 11/10; H01B 7/361

(57) ABSTRACT

Proposed is a data cable (1) for transmitting data in the telecommunications, information transmission or computer technology sectors, comprising two wires (2), wherein each wire (2) has—a conductor (3) and—an insulation layer (4), wherein the insulation layer (4) of each wire (2) has the same color additive comprising the same colorant. In order to allow improved signal transmission despite differently colored wires (2), the invention provides for an outer region (11) of the insulation layer (4) of one wire (2) to additionally have a further color additive comprising other colorants, and for an outer region (11) of the insulation layer (4) of the other wire (2) to be free of the further color additive and free of another color additive.

### FIELD OF THE INVENTION

The invention relates to a data cable for transmitting data in telecommunications, message transmission, or computer technology, comprising two wires,
each wire comprising
a conductor and
an insulation layer,
the insulation layer of each wire having the same color additive comprising the same colorants.

### PRIOR ART

Data cables, particularly those with high data transmission rates, usually comprise one or more pairs of wires and are used as a connection between a transmitter and a receiver, transmitting signals (electromagnetic waves) which are then further processed. In most cases, bidirectional communication is possible, meaning that the transmitter becomes the receiver and vice versa.

The signals can be transmitted either by means of differential signal transmission, which is a symmetrical transmission with signals in antiphase, or by means of common-mode signal transmission, which is also a symmetrical transmission but with signals in phase.

Each wire pair in a data cable comprises two conductors and two layers of insulation, each surrounding one of the two conductors. In order to enable the wire pairs to be processed further in fully automatic fashion, it is necessary that the two wires of a wire pair have different colors (externally), which is why the insulation layers are coated with corresponding colored layers. However, the different colors used in the color layers have different dielectric values due to their ingredients, in particular their color pigments, which cause signals in the two wires to propagate at different speeds and to be attenuated differently. This results in the propagation of the signals in the two wires to be asymmetrical or time-shifted relative to one another over the length of the data cable. This means, among other things, that the signal transit times are different, which affects the transmission of the signals or data.

This is called mode conversion, which is usually a measure of how good the quality of the signal transmission is.

U.S. Pat. No. 5,187,329 A, U.S. Pat. No. 1,968,903 A, WO 2018/197365 A1, U.S. Pat. No. 5,281,764 A, and US 2010/307790 A1 all disclose cables with two cores in which the insulation layer of each core is surrounded by a color layer, each of the color layers of the two cores having different colors.

### OBJECT OF THE INVENTION

It is therefore an object of the present invention to provide a data cable for transmitting data in telecommunications, message transmission, or computer technology which overcomes the disadvantages of the prior art and makes improved signal transmission possible despite differently colored wires.

### DESCRIPTION OF THE INVENTION

This object is achieved according to the invention by a data cable for transmitting data in telecommunications, message transmission, or computer technology comprising two wires,
each wire comprising
a conductor and
an insulation layer,
the insulation layer of each wire having the same color additive comprising the same colorants,
wherein
an outer region of the insulation layer of a core additionally comprises a further color additive comprising other colorants and
an outer region of the insulation layer of the other core is free of the further color additive and free of another color additive.

In the data cable according to the invention, the insulation layer of each wire contains the same color additive comprising the same colorants. In addition, the outer region of a core contains a further color additive comprising colorants other than those colorants contained in the color additive with which the insulation layer of each core is provided. The outer region of the other core is free of the further color additive comprising other colorants and free of all further color additives comprising the other colorants and/or further colorants. This means that the outer region of the insulation layer of the other wire does not contain any further color additive. The outer region therefore only contains the color additive and no other color additive in addition thereto.

The outer region of the insulation layer is therefore the region which is located farthest outward in a radial direction in the cross section of the data cable according to the invention.

Through the addition of the same color additive to the insulation layer of each core, it is ensured that the properties of the cores, particularly the attenuation properties, remain the same, whereby the cores are standardized or synchronized. By adding the additional color additive to the outer region of the insulation layer of one wire, it is ensured that one wire of the data cable according to the invention is visually perceptible in a color that is different from that of the other wire, which ensures fully automatic further processing. However, since only the outer region of the insulation layer of one wire is provided with the further color additive (the outer region of the insulation layer of the other wire is free of the further color additive and free of another color additive), the signal transmission properties, in particular the attenuation properties, of this one wire are substantially unchanged or changed only slightly compared to the other wire. This means that, in the data cable according to the invention, the signal transmission properties of the wires are adapted to each other as far and as well as possible despite the visual perceptibility of two different colors between the wires, which makes substantially improved signal transmission possible compared to the prior art. In other words, the coloring of the outer region of the insulation layer of one wire is sufficient to ensure fully automatic further processing while at the same time influencing the transit time shift of the signals as little as possible.

For example, it is conceivable for the data cable according to the invention to comprise two wires, in which case the insulation layers of both wires are provided with the same color additive, which comprises white colorants. In addition, the outer region of the insulation layer of one of the two wires contains a further color additive with green colorants. The two wires appear visually to be of different colors. One wire appears white, while the other wire appears green, although it is of course not impossible for other color combinations to be used.

In this context, the term “colorant” refers to a substance that imparts color. For example, the colorants can be color pigments which are substantially insoluble in the application medium—in the context of the present invention, in the insulation layers—and are present as solid particles, the coloration being created through absorption and remission (scattering or reflection) of certain frequency components of the visible light.

Of course, the color pigments can also be a mixture of “different” color pigments in order to achieve a specific color tone. Moreover, it would also be possible to use (liquid) colorants that are soluble in the application medium, such as a polymer.

The color additives cause at least the insulation layers to be colored due to the colorants. However, both the color additive, which all insulation layers contain, and the further color additive can of course also contain other additives in addition to the colorants, whereby the insulation layers can be optimally adapted to the respective application.

For example, the color additives may contain—in addition to the colorant—a carrier material, anti-aging agents, dispersing agents, fillers, compatibilizers, light stabilizers, processing aids, or lubricants and/or nucleating agents. The carrier material can be a polymer or a mixture of polymers, which is usually identical to the application medium. Alternatively, it can be a polymer or a mixture of polymers that is compatible with the application medium and does not have a substantial negative impact on its properties. Antioxidants are usually used as anti-aging agents to prevent or reduce the degradation of the carrier material or all other ingredients of the color additives during processing and use. Dispersing agents improve the miscibility and dispersibility of the colorants in the carrier material, while fillers, which are usually mineral flours, increase the opacity of the color additives and improve their economic manufacturability. Compatibilizers are used to improve the compatibility of the color additives with the application medium and/or the compatibility of the colorants with the carrier material. Light stabilizers are UV stabilizers that prevent or reduce degradation of the polymer and/or colorants. Processing agents or lubricants can reduce “production pressure” in the machines and enable better processability. Nucleating agents, also called nucleants, influence the product properties of the final products. As will readily be understood, the provision of additional additives such as antistatic agents, antiblocking agents, optical brighteners, effect pigments, etc., cannot be ruled out.

Of course, it is not excluded that the data cable according to the invention has more than two wires. For example, the data cable may have three, four, five, six, or even more wires, in which case the outer region of the insulation layer of at least one wire additionally comprises the further color additive comprising other colorants, and the outer region of the insulation layer of at least one other wire is free of the further color additive and free of another color additive.

One influencing factor for both the visual perceptibility of the different colors of the wires and the improved signal transmission is the thickness of the outer region of the insulation layers, particularly of the wire(s) that additionally contain the further color additive. On the one hand, the outer region must be thick enough to provide sufficient volume for the further color additive, in particular for the other colorants, so that the additional color additive, in particular the other colorants, can be adequately distributed, and on the other hand, it must be thin enough to have as little influence as possible on the signal transmission properties, in particular the attenuation properties, of the wire, despite the addition of the further color additive. Therefore, in one design variant of the invention, a provision is made that the outer region of the insulation layer of each wire has a thickness of between 5 μm and 200 μm, preferably between 25 μm and 100 μm, especially preferably between 40 μm and 60 μm. These thickness ranges represent the optimum in terms of sufficient coloring of one wire while at the same time delaying the transit of the signals only slightly.

In order to obtain a coloring of the one wire that is sufficient for fully automatic further processing, another design variant of the invention makes a provision that a total composition of the insulation layer of the one wire comprises no more than 5% by weight, preferably no more than 3% by weight, especially preferably no more than 1.5% by weight, of the further color additive. These quantities represent the optimum for sufficient visual perceptibility and only a minor influence on the signal transmission properties, in particular attenuation properties, of one wire.

In order to enable the data cable according to the invention to be manufactured in an efficient, particularly in an economically efficient manner, another design variant of the invention makes a provision that the insulation layer of each wire is produced by extrusion. Extrusion makes it possible to create various shapes with little effort and to process different materials reliably.

In another design variant of the invention, the insulation layer of each wire is made of polypropylene. Polypropylene is advantageous because the molecular structure, the level of the average molecular weight, the molecular weight distribution, the crystallinity, and the spherulite structure can be varied within wide limits, enabling the properties to be influenced. Furthermore, the dynamic load capacity of polypropylene is high and qualifies the material for a wide range of applications. What is more, the dielectric constant and the dielectric loss factor are largely independent of temperature.

In another design variant of the invention, a provision is made that the insulation layer of each wire comprises
an inner insulation layer which covers an outer surface of the conductor at least in some portions, and
an outer insulation layer which covers an outer surface of the inner insulation layer at least in some portions,
the outer insulation layer comprising the outer region. This means that both the inner insulation layer and the outer insulation layer of each core are provided with the same color additive comprising the same colorants. In addition, the outer insulation layer of one wire comprises the outer region of the insulation layer, which outer region additionally comprises the further color additive comprising other colorants. In particular, the outer insulation layer consists of the outer region of the insulation layer.

The outer insulation layer gives the data cable according to the invention stability and serves as protection against the environment.

In particular, if parts of the insulation layers are made at least in some portions of a foamed material, it is sometimes necessary to separate the foamed material from the conductors. Therefore, a provision is made in another design variant of the invention that the inner insulation layer of each wire comprises
an inner skin layer which covers the outer surface of the conductor at least in some portions, and
a main layer which covers the inner skin layer at least in some portions.

It is therefore conceivable for the main layer to be made, at least in some portions, of a foamed material and for the inner skin layer to be made of a different material, with the inner skin layer serving as a separation between the conductor and the main layer. It thus separates the main layer from the conductor, provides a certain stability, and conforms to the conductor accordingly.

A main layer of foamed material ensures optimal transmission properties of the data cable according to the invention.

In another design variant of the invention, the data cable is a shielded twisted pair data cable. This variant of the data cable according to the invention has a shielding which very effectively prevents interference from entering (or leaving) the cable. In addition, the wires of at least one wire pair are crossed, twisted, or stranded. The advantage of crossed, twisted, or stranded wire pairs is that external noise or interference signals are coupled as evenly as possible into both wires of the wire pair. Although coupled interference changes the signals on the wires, the difference between the signals is changed only slightly. A combination of braiding and shielding has proven to be very effective in reducing internal and external electromagnetic influences.

In another design variant of the invention, the data cable is a shielded parallel pair data cable. Here, the wires of at least one wire pair run substantially parallel to one another. At the same time, shielding is provided. The advantage of this design variant is that the data cable is very flexible due to the parallel wires, which makes it easy to install.

In another design variant of the invention, the data cable is an unshielded twisted pair data cable. This variant of the data cable according to the invention has twisted wires of each wire pair, but no shielding. This is the “simplest” version of a twisted pair cable, whose advantage lies particularly in its economical manufacturability.

### BRIEF DESCRIPTION OF THE FIGURES

The invention will now be explained in greater detail with reference to exemplary embodiments. The drawings constitute examples and are intended to illustrate the inventive concept but are in no way intended to restrict it or even represent it exhaustively.

In the Drawings:

FIG. 1 shows a schematic sectional view of a wire pair of a data cable according to the prior art;

FIG. 2 shows a schematic mode conversion curve of the data cable according to the prior art;

FIG. 3 shows a schematic sectional view of a wire pair of a first exemplary embodiment of a data cable according to the invention;

FIG. 4 shows a schematic mode conversion curve of the first exemplary embodiment of the data cable according to the invention; and

FIG. 5 shows a schematic view of a wire pair of a second exemplary embodiment of the data cable according to the invention.

### MANNER OF CARRYING OUT THE INVENTION

FIG. 1 shows a schematic sectional view of a wire pair, i.e., two wires 2, of a data cable 1 for transmitting data in telecommunications, message transmission, or computer technology according to the prior art. Each of the two wires 2 has a conductor 3 and an insulation layer 4 comprising an inner insulation layer 5 and an outer insulation layer 6 formed by an outer region 11 of the insulation layer 4, the inner insulation layer 5 covering an outer surface 7 of the conductor 3 and the outer insulation layer 6 covering an outer surface 8 of the inner insulation layer 5. In other words, the inner insulation layer 5 is arranged between the conductor 3 and the outer insulation layer 6.

In order to enable the wires 2 to be processed fully automatically, they have different colors. One of the two wires 2 is visually perceptible as green (left wire 2 in FIG. 1), while the other of the two wires 2 is visually perceptible as white (right wire 2 in FIG. 1).

In order to achieve a different visual perceptibility of the two wires 2, the insulation layer 4 of one wire 2 is provided with green colorants (the green colorants are symbolized by the dots in the insulation layer 4), and the insulation layer 4 of the other wire 2 is provided with white colorants. This means that for both cores 2, both the inner insulation layer 5 and the outer insulation layer 6 contain different colorants.

These different colorants have different dielectric values, which cause the signals in the two wires 2 to propagate at different speeds and to be attenuated differently. This means that the propagation of the signals in the two wires 2 over the length of the data cable 1 is not symmetrical, which means, among other things, that the signal transit times are different. This is referred to as mode conversion.

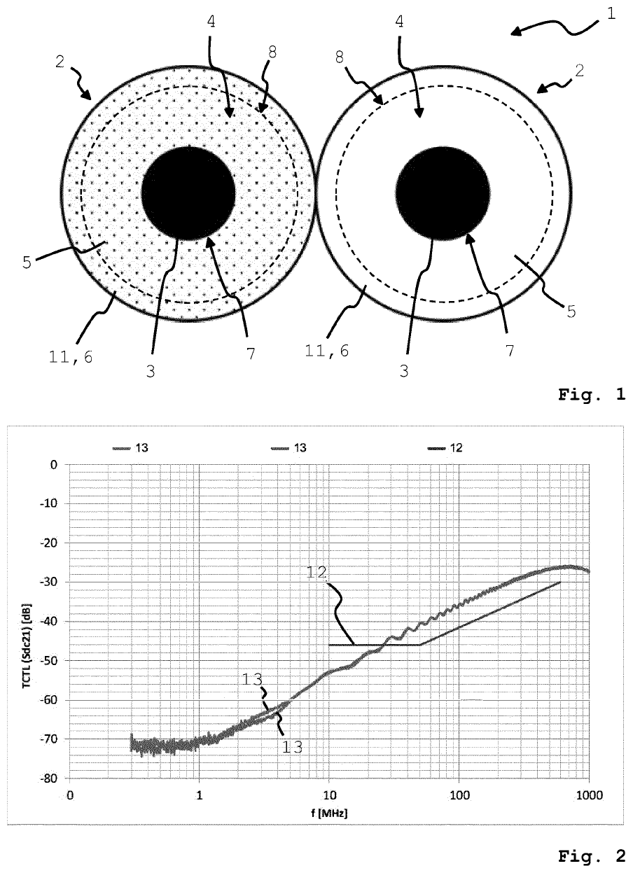

FIG. 2 shows a mode conversion curve of the data cable 1 according to the prior art. Here, the TCTL (Transverse Conversion Transfer Loss) parameter is plotted against the frequency, the TCTL parameter being a measure of the asymmetric attenuation (i.e., mode conversion) of a data cable 1. This means that the lower the TCTL parameter, the better the attenuation properties of the data cable 1 and the better (more symmetrical) the signal transmission between the wires 2 of the data cable 1 is.

In FIG. 2, three lines are visible, namely a TCTL parameter 13 of each of the two wires 2 of the data cable 1 according to the prior art and a limit line 12. To ensure good signal transmission, the TCTL parameters 13 of both wires 2 should be arranged below the limit line 12 over the entire frequency range. It can be seen from FIG. 2 that this is not the case with the data cable 1 according to the prior art. Between 20 and 30 MHz, the TCTL parameters 13 of both wires 2 exceed the limit line 12 and then remain permanently above the limit line 12. This means that, at frequencies greater than or equal to 20-30 MHz, the limit line 12 is exceeded by the TCTL parameters 13. Thus, in the data cable 1 according to the prior art, there are significant delays in the signals in the two wires 2 in the higher frequency range—i.e., an asymmetrical signal transmission takes place.

FIG. 3 shows a schematic sectional view of a wire pair, i.e., two wires 2, of a first exemplary embodiment of a data cable 1 according to the invention. The structure of the first exemplary embodiment of the data cable 1 according to the invention, in particular of the insulation layers 4, corresponds substantially to the structure of the data cable 1 shown in FIG. 1 according to the prior art. Although only two wires 2 are shown in FIG. 3, it is not excluded that the data cable 1 also has more wires 2, for example three, four, five, six, or more wires 2.

However, the coloring of the insulation layers 4 is different. In the first exemplary embodiment of the data cable 1 according to the invention, the insulation layers 4 of the two wires 2, i.e., both the inner insulation layers 5 and the outer insulation layers 6, which outer insulation layers 6 are formed from the outer region 11 of the insulation layers 4 and, in the first exemplary embodiment, have a thickness of substantially 50 μm, each have the same color additive comprising the same white colorants. In addition, the outer insulation layer 6 of one of the two wires 2 (left wire 2 in FIG. 3) comprises a further color additive comprising green colorants. The outer insulation layer 6 of the other of the two wires 2 (right wire 2 in FIG. 3) is free of the further color additive and free of another color additive. Thus, one wire 2 is visually perceptible as green (left wire 2 in FIG. 3), and the other wire 2 is visually perceptible as white (right wire 2 in FIG. 3).

In this design variant, the total compositions of the insulation layers 4 of the two wires 2 each comprise 1% by weight of the color additive comprising white colorants. In addition, the total composition of the left wire in FIG. 3 comprises 1.78% by weight of the further color additive, the further color additive being composed in this case of the same amount of white colorants and green colorants. This means that the additional color additive contains not only the green colorants but also the same amount of white colorants. Thus, the data cable 1 according to the invention can be further processed fully automatically on the one hand and, on the other hand, the signal transmission properties of the wire 2, which is visually perceptible as green, are only slightly influenced compared to the wire 2, which is visually perceptible as white.

The insulation layers 4 of both wires 2 of the first exemplary embodiment are made by extrusion of polypropylene.

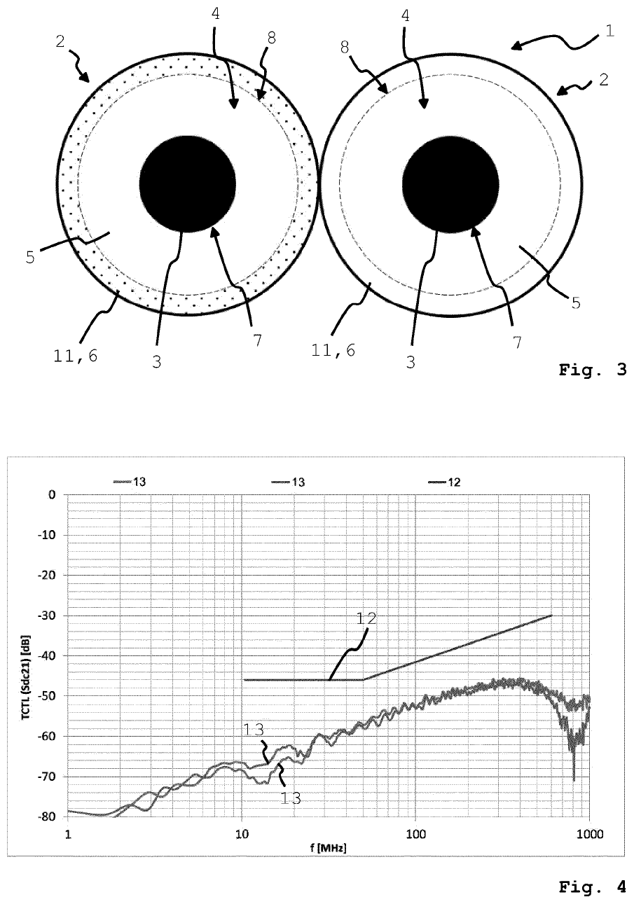

FIG. 4 shows a mode conversion curve of the first exemplary embodiment of the data cable 1 according to the invention. Here again, the TCTL parameter is plotted against the frequency, just as in FIG. 2. Three lines are also visible in FIG. 4, namely a TCTL parameter 13 of each of the wires 2 and the limit line 12 known from FIG. 2.

It can be seen from FIG. 4 that, in the data cable 1 according to the invention, the TCTL parameters 13 of both wires 2 are well below the limit line 12 over the entire frequency range. Thus, the signal transmission properties of the two wires 2 of the first design variant of the data cable 1 according to the invention are well matched to one another despite the visual perceptibility of different colors (one wire 2 is visually perceptible as green, the other wire 2 white), which makes a substantially improved signal transmission possible compared to the prior art.

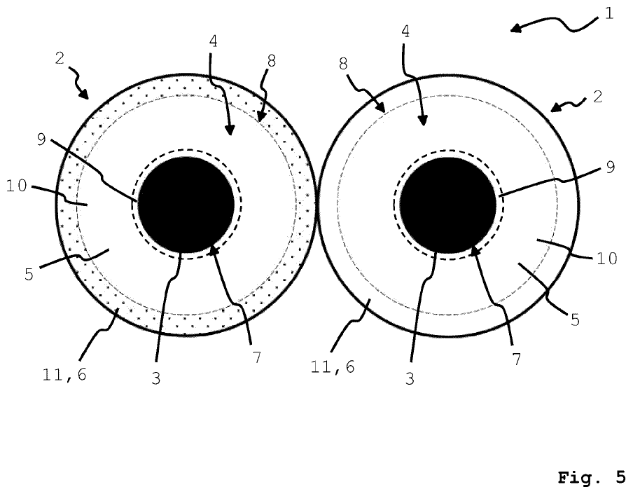

FIG. 5 shows a schematic sectional view of a wire pair, i.e., two wires 2, of a second exemplary embodiment of the data cable 1 according to the invention. The second exemplary embodiment corresponds to the first exemplary embodiment of the data cable 1 according to the invention with the difference that the inner insulation layers 5 of the two wires 2 have an inner skin layer 9 and a main layer 10, the inner skin layer 9 being arranged between the conductor 3 and the main layer 10. The inner skin layer serves as a separation between the conductor 3 and the main layer 10 and provides stability.

Both the first exemplary embodiment of the data cable 1 according to the invention and the second exemplary embodiment of the data cable 1 according to the invention can be embodied as a shielded twisted pair data cable 1, a shielded parallel pair data cable 1, or an unshielded twisted pair data cable 1.

### LIST OF REFERENCE SYMBOLS

1 data cable
2 wire
3 conductor
4 insulation layer
5 inner insulation layer
6 outer insulation layer
7 outer surface of the conductor 3
8 outer surface of the inner insulation layer 5
9 inner skin layer
10 main layer
11 outer region of the insulation layer 4
12 limit line
13 TCTL parameters of one of the wires 2 of the data cable 1

1. A data cable (1) for transmitting data in telecommunications, message transmission, or computer technology, comprising
two wires (2),
each wire (2) comprising
a conductor (3) and
an insulation layer (4),
wherein
the insulation layer (4) of each wire (2) having the same color additive comprising the same colorants,
an outer region (11) of the insulation layer (4) of a wire (2) further comprises a further color additive comprising other colorants, and
an outer region (11) of the insulation layer (4) of the other wire (2) is free of the further color additive and free of another color additive.

2. The data cable (1) according to claim 1, wherein the outer region (11) of the insulation layer (4) of each wire (2) has a thickness of 5 μm to 200 m.

3. The data cable (1) according to claim 1, wherein a total composition of the insulation layer (4) of the one wire (2) comprises no more than 5% by weight of the further color additive.

4. The data cable (1) according to claim 1, wherein the insulation layer (4) of each wire (2) is produced by extrusion.

5. The data cable (1) according to claim 1, wherein the insulation layer (4) of each wire (2) is made of polypropylene.

6. The data cable (1) according to claim 1, wherein the insulation layer (4) of each wire (2) comprises
an inner insulation layer (5) which covers an outer surface (7) of the conductor (3) at least in some portions, and
an outer insulation layer (6) which covers an outer surface (8) of the inner insulation layer (5) at least in some portions, wherein the outer insulation layer (6) comprises the outer region (11).

7. The data cable (1) according to claim 6, wherein the inner insulation layer (5) of each wire (2) comprises
an inner skin layer (9) which covers the outer surface (7) of the conductor (3) at least in some portions, and
a main layer (10) which covers the inner skin layer (9) at least in some portions.

8. The data cable (1) according to claim 1, wherein the data cable (1) is a shielded twisted pair data cable.

9. The data cable (1) according to claim 1, wherein the data cable (1) is a shielded parallel pair data cable.

10. The data cable (1) according to claim 1, wherein the data cable (1) is an unshielded twisted pair data cable.
